(19) United States
(12) Patent Application Publication
(10) Pub. No.: US 2008/0132815 A1
(43) Pub. Date: Jun. 5, 2008

(54) MASSAGE UNIT FOR A BACKREST, INCLUDING A BACKREST OF A CHAIR AND A PORTABLE BACKREST

(75) Inventors: Hing Wah Tsang, Ajax (CA); David Riley Markam, Markham (CA); Pei Xiong Li, Ajax (CA)

Correspondence Address: BERESKIN AND PARR, 40 KING STREET WEST, BOX 401, TORONTO, ON, M5H 3Y2, omitted

(73) Assignee: INTEGRAL ORTHOPEDICS INC., Toronto (CA)

(21) Appl. No.: 11/872,274

(22) Filed: Oct. 15, 2007

Related U.S. Application Data
(60) Provisional application No. 60/932,980, filed on Oct. 18, 2006.

(51) Int. Cl. A61H 15/00

(52) U.S. Cl. 601/91

(57) ABSTRACT

A massage unit wherein at least some of the massage heads move in an alternating direction so as to define alternating cooperating pairs of massage heads is provided.

### FIELD OF THE INVENTION

This invention relates to massage units for the back of a user. In particular, the invention relates to a massage unit which may be incorporated into a backrest, such as a probable backrest which may be transported by a person from location to location, or a backrest of a chair, such as an office chair or lounge chair.

### BACKGROUND OF THE INVENTION

It is known to incorporate different devices into a portable backrest or backrest of a chair to treat the back of a person. These could be broadly classified into two families. One family involves the use of vibrators or vibration pads that are mounted at fixed locations in a backrest. These vibrators treat the plurality of discreet locations on the back of a person who is leaning against the backrest. These devices do not provide a massage action. Instead, they merely provide vibration pulses at discreet locations on a user's back.

The other general class of devices that are known in the art utilize massage heads that are movably mounted. Various different types are known in the art, and various different drive mechanisms are utilized to produce the desired motion.

For example, Swanson (U.S. Pat. No. 4,454,867) utilizes a plurality of rotatably mounted Y shaped members wherein each arm of the Y shaped member has a plurality of massage heads. The Y shaped members may be arranged, for example, in a two by two array. In use, the massage heads will essentially describe a circular pattern on the back of a user. Tseng (U.S. Pat. No. 7,077,816) utilizes a plurality of massage blocks each of which is rotatably mounted. Luo (U.S. Pat. No. 7,081,099) is entitled foot massager and discloses the use of rotatably mounted massage heads wherein each massage head is provided with pressure balls. Accordingly, these references also disclose the use of circular action.

Phillips et al (U.S. Pat. No. 5,843,006) discloses a massage device that comprises sets of pairs of fingers wherein each pair of fingers are biased apart. In operation, each pair of fingers pivotally and transversely reciprocate so that the outer ends of the fingers move towards and away from one another. In use, the operator places the case such that the outer ends of the fingers contact the area to be massaged. Accordingly, in operation, the device of Phillips et al treats a selected area of the body of a user.

### SUMMARY OF THE INVENTION

In accordance with a first aspect of the instant invention, a massage unit, which may be incorporated into a portable backrest or a backrest of a chair, is provided which more accurately simulates a massage action than some massage units that are known in the art. In order to simulate a massage action, at least one massage head alternately moves towards and away from another massage head. Accordingly, when a user reclines against the backrest, the travel of the massage head over the back of a person tends to draw the portion of the skin of the person together and apart, thereby simulating the squeezing action and the subsequent release action utilized by a massage therapist. Preferably, a plurality of moveable massage heads are provided on each side of the spine of a user so as to treat essentially the entire back of a user.

In a preferred embodiment, the massage heads track generally vertically (e.g., they may track along an arc). At least some of the massage heads, and preferably, all of the massage heads, preferably travel generally vertically alternately up and down along the back of the user. This provides a different effect than the use of massage heads that rotate in a circle.

In accordance with a second alternate aspect of the instant invention, a massage unit is provided wherein the massage heads may move inwardly or outwardly to vary the amount of contact with the back of a user. In particular, the extent to which the massage heads extend outwardly from the massage unit is variable, independent of the massage action provided by the massage heads. Accordingly, while the massage unit is operating, a user may vary the extent to which the massage heads extend outwardly of the massage unit without affecting the massage movement of the massage heads. Preferably, a plurality of massage heads are provided and the degree of inward/outward motion may be independently controlled for at least some of the massage heads. In a particularly preferred embodiment, a plurality of pairs of massage heads are provided wherein the degree of inward/outward motion for each pair of massage heads is adjustable independent of the outwardly position of any other pair of massage heads. This may be achieved by using a separate depth adjustment motor for each pair of massage heads.

It will be appreciated that a massage unit may utilize either the massage motion of the first aspect, the independent depth adjustment of the second aspect or both the massage motion of the first aspect and the independent depth adjustment of the second aspect.

Accordingly, in accordance with one embodiment of the instant invention, there is provided a massage unit comprising a first plurality of massage heads positioned to be on one side of a spine of a user when the massage unit is in use, at least one of the massage heads is moveable in alternating directions and sequentially cooperates with other massage heads to define alternating cooperating pairs of massage heads.

In one embodiment, the first plurality of massage heads comprises at least first, second and third massage heads, and the second massage head is positioned between the first and third massage heads and is moveable in alternating directions between a first position proximate the first massage head and a second position proximate the third massage head.

In another embodiment, in use, the first, second and third massage heads are vertically spaced apart.

Alternately, or in addition, in another embodiment, the first and third massage heads are moveably mounted and the first, second and third massage heads move between a first configuration wherein the first and third massage heads are distal to one another and the first and second massage heads are proximate to each other and a second configuration wherein the second massage head is further from the first massage head and closer to the third massage head.

Alternately, or in addition, in another embodiment, the first, second and third massage heads oscillate.

Alternately, or in addition, in another embodiment, the first and third massage heads are moveably mounted and the second massage heads travels in an alternate direction to the first and third massage heads.

Alternately, or in addition, in another embodiment, the first and third massage heads are moveably mounted and the first, second and third massage heads travel in a plane substantially parallel to the back of a user.

Alternately, or in addition, in another embodiment, at least one of the first, second and third massage heads is moveably mounted in a direction generally perpendicular to the plane. Preferably, at least two of the massage heads are independently moveably mounted in a direction generally perpendicular to the plane.

Alternately, or in addition, in another embodiment, the massage heads travel in an arcuate path.

The massage unit may be built into a chair back of a chair or may be portable and is adapted to be mounted on a chair back of a chair.

In accordance with another embodiment of the instant invention, there is provided a massage unit comprising:
(a) a first plurality of massage heads positioned to be, when used, on one side of a spine of a user and spaced apart by a first distance;
(b) a second plurality of massage heads positioned to be, when used, on another side of a spine of the user and spaced apart by a second distance; and,
(c) a massage unit of the first plurality is linked to a massage unit of the other plurality and moves in an opposite direction to the massage unit of the other plurality
wherein, in use, as the first distance increases, the second distance decreases and as the first distance decreases, the second distance increases.

In one embodiment, in use, at least two of the massage heads of the first plurality move alternately towards each other and away from each other and at least two of the massage heads of the second plurality move alternately towards each other and away from each other.

In another embodiment, each of the first and second plurality of massage heads comprises at least first, second and third massage heads, each second massage head being positioned between a first massage head and a third massage heads and, in use, as the first and second massage heads of the first plurality move towards each other, the third massage head moves away from the second massage head of the first plurality.

In another embodiment, the massage unit comprises a plurality of sets of massage heads, each set of massage heads comprising at least two massage heads positioned on an arm that, in use, is pivotally mounted about a generally horizontal axis and the arm extends across a spine of a user such that at least one head of each set contacts the user on a different side of the user's spine.

In another embodiment, the arm has a midpoint and the arm is rotatably mounted at the mid point.

In another embodiment, the massage unit includes three arms that are spaced vertically apart.

In another embodiment, the massage heads travel in an arcuate path, the arcuate path has a centre and the arm is generally horizontal when the massage heads are at the centre of the arcuate path.

In accordance with another embodiment of the instant invention, there is provided a massage unit for a back of a user comprising:
(a) a plurality of sets of massage heads, each set comprising at least first and second massage heads positioned on opposite sides of a spine of the user; and,
(b) at least one of the sets of massage heads is moveably mounted and the massage heads of that set are connected together such that the massage heads on one side of the spine of the user move in the opposite direction to the massage heads on the other side of the spine of the user.

In one embodiment, the first massage head sequentially moves in alternate directions.

In another embodiment, the at least first and second massage heads of a set are positioned on an arm that, in use, is pivotally mounted about a generally horizontal axis and the arm extends across the spine of the user.

In another embodiment, the arm has a midpoint and the arm is rotatably mounted at the mid point.

In another embodiment, the massage unit comprises an upper set, a middle set and a lower set, each of which is moveably mounted and the middle set moves in a direction counter to a direction of movement of the upper and lower sets.

In another embodiment, the massage heads travel in an arcuate path.

In another embodiment, the arcuate path has a centre and the arm is generally horizontal when the massage heads are at the centre of the arcuate path.

In accordance with another embodiment of the instant invention, there is provided a massage unit for a back of a user comprising a plurality of sets of massage heads, each set is moveably mounted and comprises at least first and second massage heads positioned on opposite sides of a spine of the user, and at least one set is driven to move in a direction counter to an adjacent set.

In one embodiment, the at least one set sequentially moves in alternate directions.

In another embodiment, each set comprises an arm that, in use, is pivotally mounted about a generally horizontal axis and the arm extends across the spine of the user.

In another embodiment, the massage unit comprises an upper set, a middle set and a lower set, each of which is moveably mounted and the middle set moves in a direction counter to a direction of movement of the upper and lower sets.

In another embodiment, the massage heads travel in an arcuate path. Preferably, the arcuate path has a centre and the arm is generally horizontal when the massage heads are at the centre of the arcuate path.

In accordance with another embodiment of the present invention, there is provided a massage unit comprising:
(a) a front support;
(b) an arm pivotally mounted about an axis defined by a driveshaft, the arm pivotal in an arc about the axis in a plane generally parallel to the front support;
(c) at least one massage head mounted to the arm;
(d) a motor drivingly coupled to the arm;
(e) the draft shaft is rotatably mounted to the massage unit and moveable in a direction generally perpendicular to the front support; and,
(f) a depth adjustment motor drivingly coupled to the driveshaft.

In one embodiment, the front support has an opening through which the massage head extends and rotation of the driveshaft in one direction moves the massage head outwardly with respect to the opening.

In one embodiment, the massage unit further comprises another massage head mounted to the arm. In a further embodiment, the arm has a midpoint, the arm is rotatably mounted on the driveshaft at the midpoint and a massage head is provided at opposed ends of the arm.

In one embodiment, the massage unit comprises a plurality of arms, a plurality of driveshafts, and a plurality of depth adjustment motors, each of the arms is rotatably mounted on one of the driveshafts, and each of the driveshafts is drivenly coupled to one of the depth adjustment motors. In a further embodiment, each arm is independently movable in a direction generally perpendicular to the front support.

In one embodiment, the massage unit further comprises a speed reduction gear driven by the depth adjustment motor and having an inner threaded opening, and the driveshaft has a mating threaded outer surface that is rotatably received in the inner threaded opening of the speed reduction gear.

In one embodiment, the massage unit further comprises a plurality of speed reduction gears provided between the driveshaft and the depth adjustment motor.

In one embodiment, the depth adjustment motor is secured at a fixed location to the massage unit.

In one embodiment, the motor coupled to the arm to move the arm in the plane substantially parallel to the back of the user causes to arm to oscillate.

In one embodiment, the massage unit is built into a chairback of a chair. Alternatively, the massage unit is portable and is adapted to be mounted on a chair back of a chair.

### BRIEF DESCRIPTION OF THE DRAWINGS

These and other advantages of the instant invention will be more fully and completely understood in accordance with the following drawings of a preferred embodiment of the instant invention and which:

FIG. 1 is a front elevation view of a backrest incorporating a massage unit in accordance with a preferred embodiment of the instant invention;

FIG. 2 is a top view of the embodiment of FIG. 1;

FIG. 3 is a side view of the massage unit of FIG. 1;

FIG. 4 is an exploded view of the massage of FIG. 1;

FIG. 5 is a front plan view of the massage unit of FIG. 4 with the front cover removed;

FIG. 6 is a front plan view of the massage unit of FIG. 1 with the track drive removed;

FIG. 7 is a front plan view of the massage unit of FIG. 1 with the massage head and massage arms removed;

FIG. 8 is a front plan view of a pair of massage heads mounted to an arm and the drive mechanism for the arm;

FIG. 9 is a rear plan view of FIG. 8;

FIG. 10 is a side view of the embodiment of FIG. 8;

FIG. 11 is a top plan view of the embodiment of FIG. 8;

FIG. 12 is an exploded view of the mechanism of FIG. 8;

FIG. 13 is a front plan view of the massage unit of FIG. 4 with the front cover removed and the massage heads in a first configuration; and,

FIG. 14 is a front plan view of the massage unit of FIG. 4 with the front cover removed and the massage heads in a second configuration.

### DETAILED DESCRIPTION OF THE INVENTION

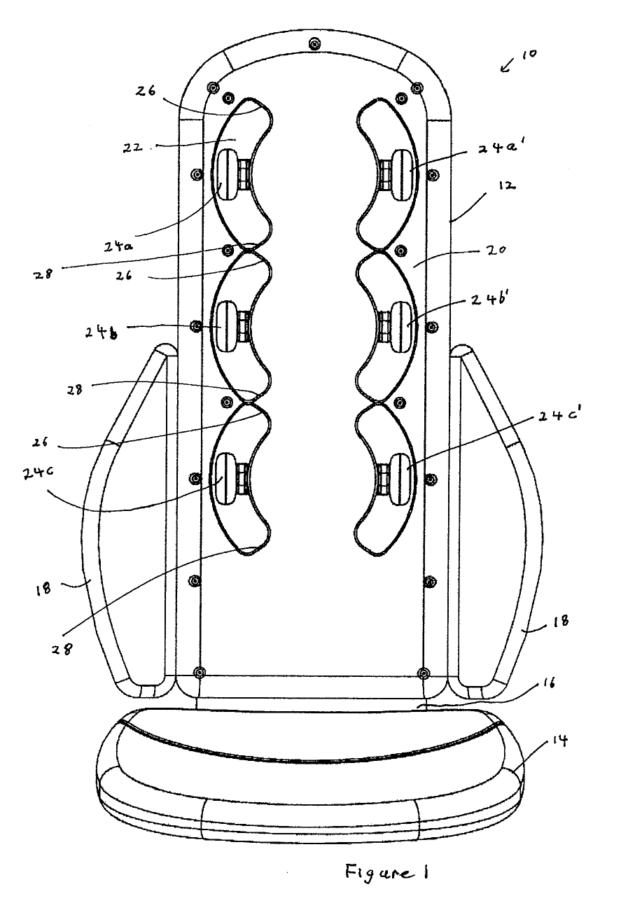

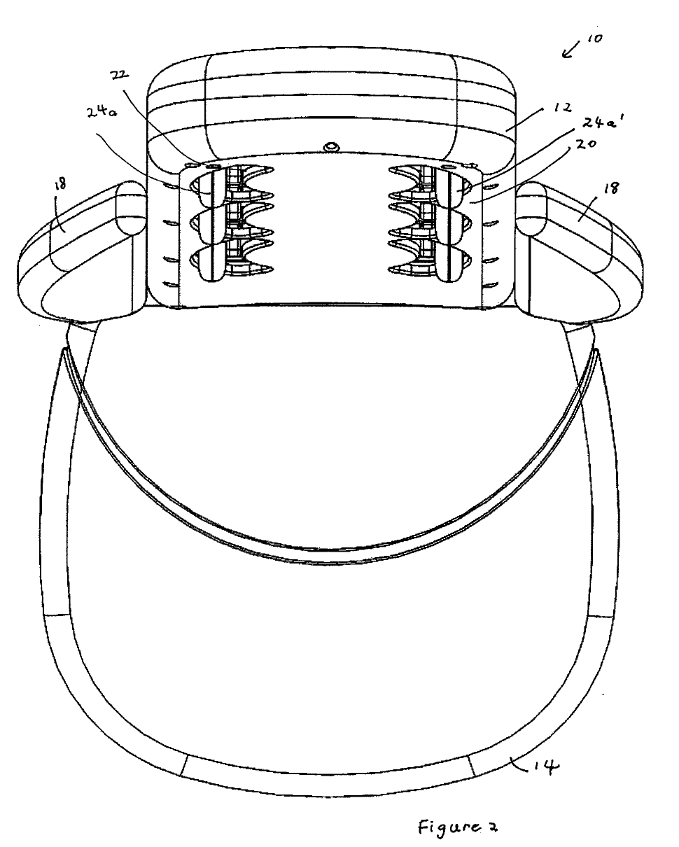

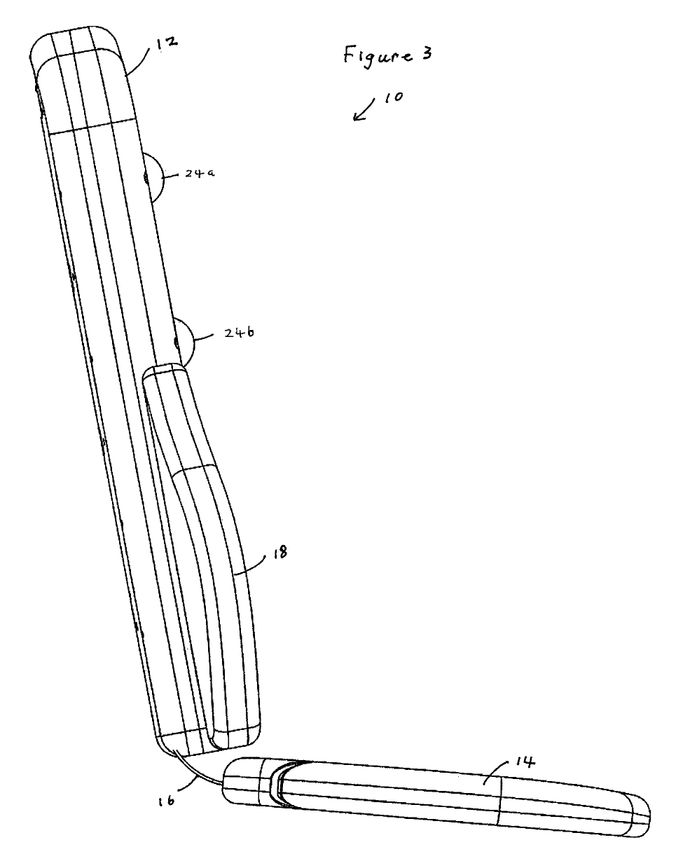

FIGS. 1-3 exemplify a portable massage unit, namely a massage unit which can be carried with a person and placed in a seat or on the floor adjacent to wall. Portable massage unit 10 comprises a backrest 12, a seat 14, a connector member 16 extending between seat 14 and backrest 12 and two handles 18. It will be appreciated by those skilled in the art that a portable massage unit may merely comprise a backrest 12. Further, in an alternate preferred embodiment, the massage unit may be incorporated into the backrest of a chair.

If the massage unit is portable, then it is preferred that at least one handle and, preferably two handles 18 are provided. These provide a convent means for carrying the portable massage unit 10.

If provided, seat 14 may be of any particular configuration, as may handles 18. Connector member 16 may be any member that is used to secure backrest 12 and seat 14 so as to define a complete unit. For example, connector member 16 may be a strip of material that is secured to the bottom of backrest 12 and the rear of seat 14.

Backrest 12 may be of any particular configuration known in the art and preferably has a width that is as wide as the back of a person. Preferably, front surface 20 of backrest 12 is essentially flat and, if backrest 12 extends vertically, then front surface 20 extends generally vertically.

Preferably, backrest 12 or at least front surface 20 thereof is covered by a material (e.g., cloth or leather) and, in addition, padding (e.g., foam or other material known in the art) may be positioned between front surface 20 and the material that may encase backrest 12.

Front surface 20 is preferably generally rigid and may be constructed from any material known in the chair arts, such as plywood or plastic. It will be appreciated that backrest 12 may flex slightly during use. However, the amount of deflection should be such so as not to inhibit the movement of the massage heads.

As exemplified, front surface 20 is provided with an opening 22 for each massage head 24. Accordingly, opening 22 defines a track or path through which massage head 24 may travel. As shown in FIG. 1, opening 22 describes an arc, which may about 70°. It will be appreciated that, in an alternate embodiment, front surface 20 may be provided with larger openings wherein a plurality of massage heads 24 may be positioned in each opening.

Massage heads 24 may be of any particular shape. As shown in the preferred embodiment, massage head are in the shape of wheels so as to be able to essentially roll across the back of a person seated against backrest 12. The wheels are preferably rotatably mounted on an axle.

In accordance with one aspect of the instant invention, massage unit 10 comprises a plurality of massage heads 24 positioned to be on one side of the spine of a user when the massage unit 10 is in use. At least one of the massage heads 24 is movable in alternating directions so as to sequentially cooperate with other massage heads 24 to define alternating cooperating pairs massage heads. Therefore, in accordance with this embodiment, a plurality of massage heads may be provided on only one side of backrest 12. When a user leans against backrest 12, the massage heads will be positioned on only one side of the spine of the user. According to this embodiment, at least two massage heads, and preferably 3 or more massage heads are vertically spaced apart on one side of backrest 12. If three massage heads are provided on one side of backrest 12, e.g., upper massage head 24a, middle massage head 24b and lower massage head 24c, then preferably at least the middle massage head 24b is movable mounted. Preferably each massage head is moveable

In a more preferred embodiment, a plurality of massage heads 24 is provided on each side of backrest 12. Accordingly, when a user leans against backrest 12, a plurality of massage heads 24 will be provided on one side of the spine of the user and a plurality of massage heads 24′ will also be provided on the other side of the spine of the user. In a most preferred embodiment, each massage head 24 on one side of backrest 12 has a spaced apart mating massaging head positioned on the other side of backrest 12. Accordingly, for example, upper massage head 24a may be associated with an opposed upper massage head 24a′ thereby defining a set of massage heads. As exemplified in FIG. 1, three sets or pairs of massage heads are provided namely upper massage heads 24a, 24a′, middle massage 24b, 24b′, and lower massage heads 24c, 24c′.

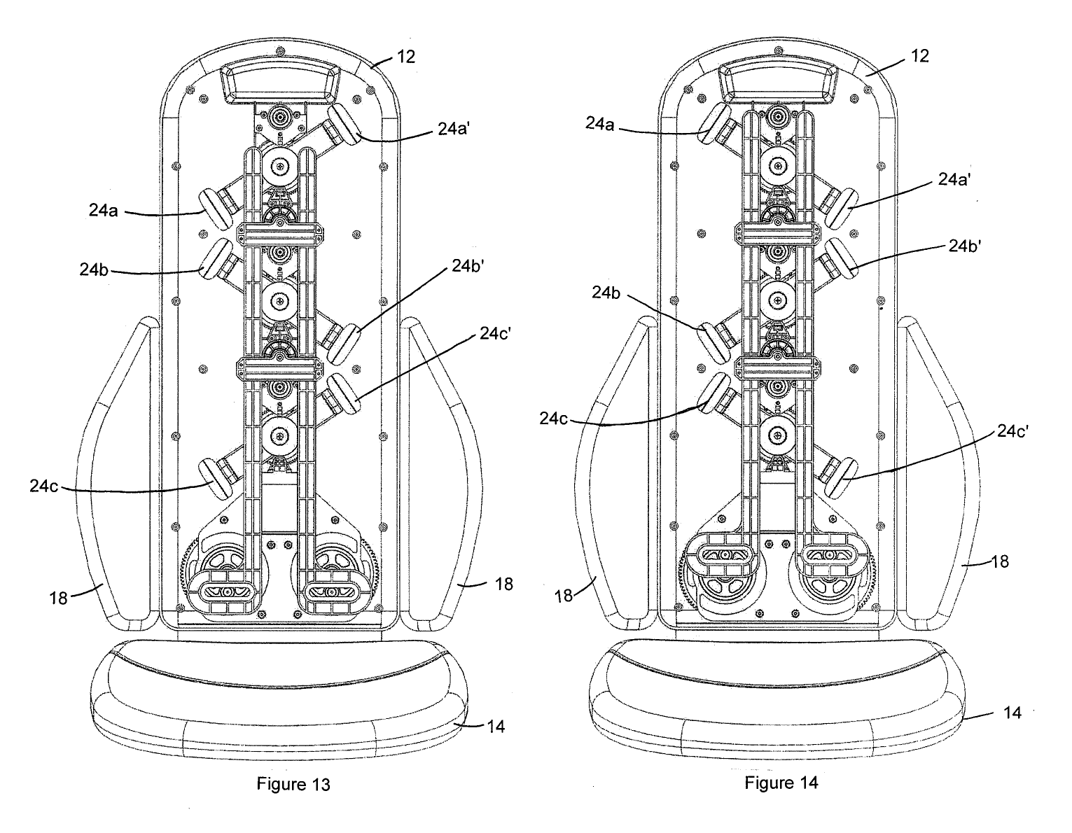

FIGS. 13 and 14 exemplify the alternating configurations available in an embodiment wherein three massage heads are provided on each side. In such an embodiment at least one massage head on each side is moveable and, preferably at least middle massage heads 24b, 24b′ are movable mounted. Massage head 24b may be moveable between a first position wherein massage head 24b is at it's upper extent of travel (e.g. adjacent top end 26 of opening 22 as shown in FIG. 13), and a second position in which massage head 24b is at its lower extent of travel (e.g. adjacent lower end 28 of opening 22 as shown in FIG. 14). Preferably, the pair of massage heads 24b, 24b′ move in alternating directions and may be 180° out of phase. Therefore, when massage head 24b is in its first position at it's upper extent of travel (e.g. adjacent top end 26 of opening 22 as shown in FIG. 13) massage head 24b′ may be at its lowest extent of travel (e.g. adjacent lower end 28 of opening 22), and when massage head 24b is in its second position at it's lowest extent of travel (e.g. adjacent lower end 28 of opening 22 as shown in FIG. 14) massage head 24b′ may be at its upper extent of travel (e.g. adjacent top end 26 of opening 22).

In a more preferred embodiment, massage heads 24a, 24a′ and 24c, 24c′ are also movable. In such an embodiment, massage heads 24a, 24a′ and 24c, 24c′ preferably move in the opposite direction of travel of massage heads 24b, 24b′. Accordingly, as shown in FIG. 13, when massage head 24b is at its upper extent of travel, massage heads 24a and 24c are at their lower extent of travel (e.g. adjacent lower end 28 of opening 22). Similarly, when massage head 24b′ is at its lower extent of travel, massage heads 24a′ and 24c′ are at their upper extent of travel (e.g. adjacent top end 26 of opening 22). Conversely, when massage head 24b is at its lower extent of travel, then massage heads 24a and 24c are preferably at their upper extent of travel (e.g. adjacent upper end 26 of openings 22 as shown in FIG. 14). Similarly, when massage head 24b′ is at its upper extent of travel, then massage heads 24a′ and 24c′ are preferably at their lower extent of travel (e.g. adjacent lower end 28 of openings 22). Accordingly, in a first configuration shown in FIG. 13, upper massage head 24a and middle massage head 24b are at their closest approach (i.e. the distance between the two is at a minimum). Accordingly, massage heads 24a and 24b in this first configuration define a cooperating pair of massage heads. When massage heads move to the other extent of travel (e.g. as shown in FIG. 14), then massage heads 24a and 24b are at their furthest extent of travel from each other (i.e. the distance between the two is at a maximum) and the distance between massage heads 24b and 24c is at a minimum. In this second configuration, massage heads 24b and 24c define a second cooperating pair of massage heads. Accordingly, as the massage heads travel (e.g., oscillate) middle massage head 24b sequentially cooperates with first massage head 24a and subsequently cooperates with massage head 24c to define alternating cooperating pairs of massage heads. Massage heads 24a′, 24b′ and 24c′ also concurrently form alternating cooperating pairs of massage heads.

When massage heads 24a and 24b move towards each other, the skin in that section of the back of a user is drawn towards each other thereby creating a squeezing type of action. When massage head 24b moves towards lower end 28 of opening 22, massage head 24a preferably moves towards upper end 26 of opening 22 thereby letting that portion of the skin of the user relax. At the same time, as massage heads 24b and 24c approach each other, the skin on the back of a user at another section of a user's back, is drawn together thereby defining another squeezing type of action. When massage head 24b moves towards a first configuration shown in FIG. 13, and preferable massage 24c moves towards lower end 28 of opening 22, then the skin in that section of the user's back is allowed to relax. Accordingly, as the massage heads travel alternately upwardly and downwardly, a series of squeezing actions and a series of releasing actions (allowing the tension in the skin of a user to relax) are created. Similarly, the same series of squeezing and releasing actions may be created by massage heads 24a′, 24b′ and 24c′ on the other side of backrest 12.

Preferably, a set of massage heads, e.g., massage heads 24a, 24a′, are configured such that the opposed massage heads of the same set move in opposite directions concurrently. Accordingly, for example, when massage head 24a moves downwardly, massage head 24a′ moves upwardly. Conversely, when massage head 24a moves upwardly, massage 24a′ moves downwardly.

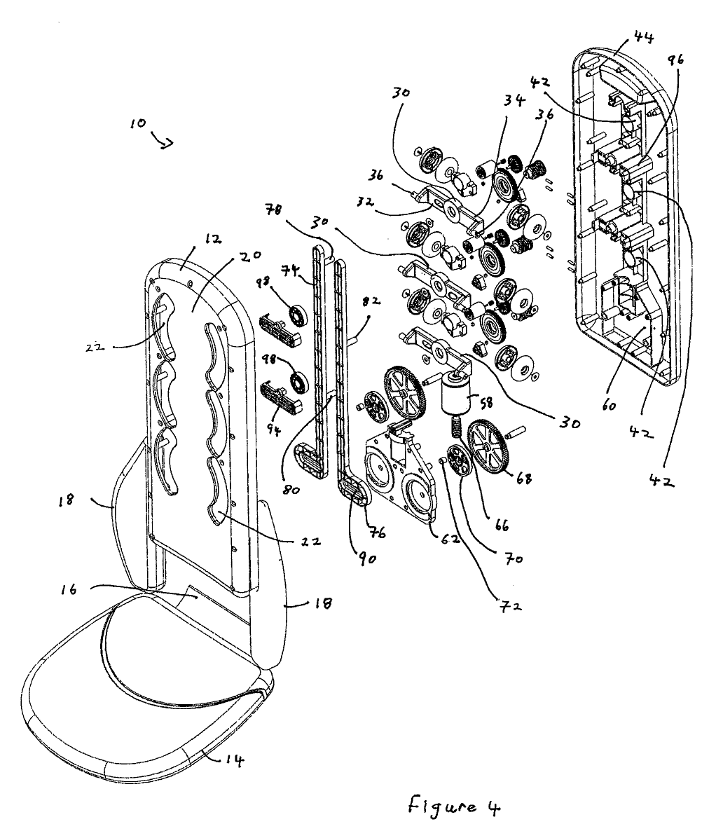

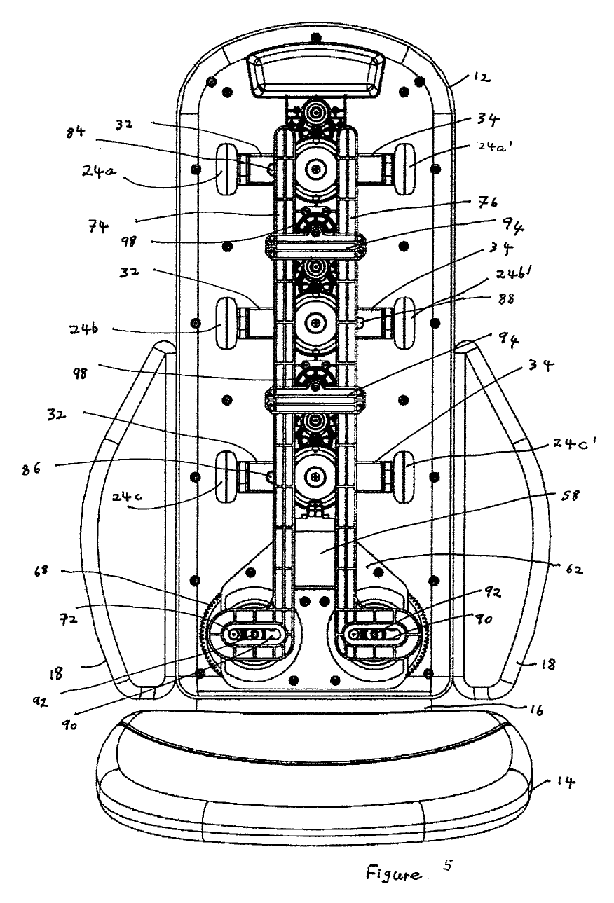

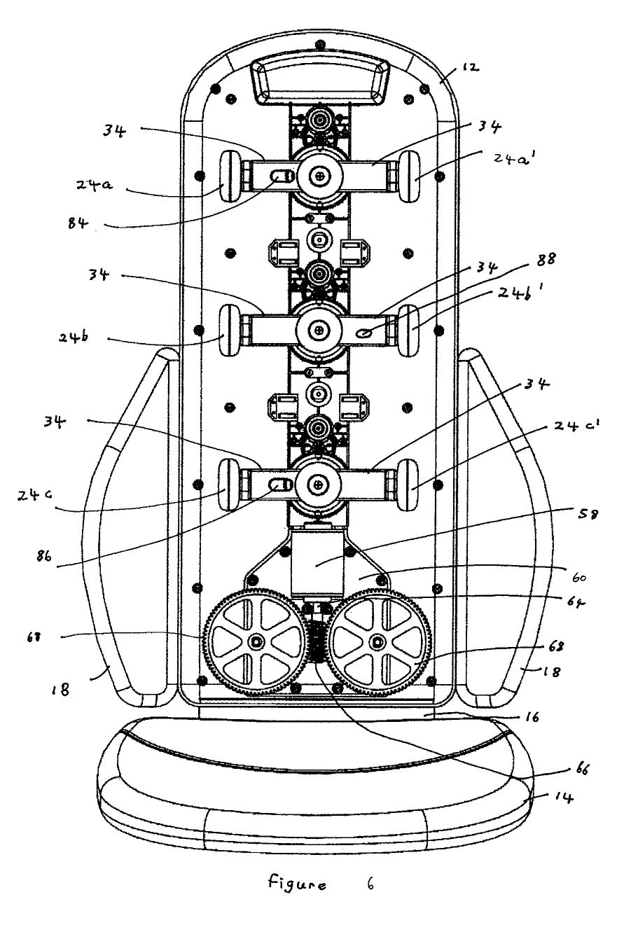

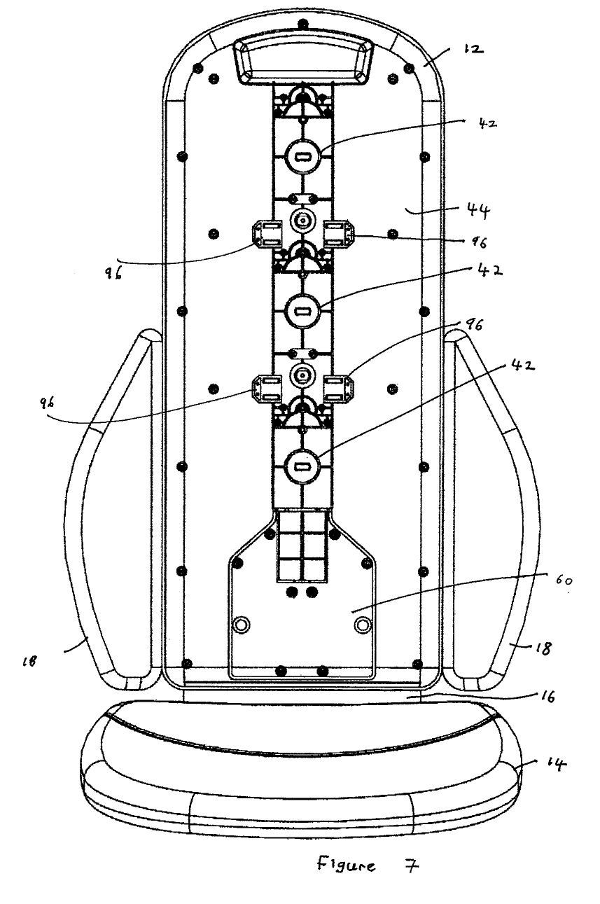

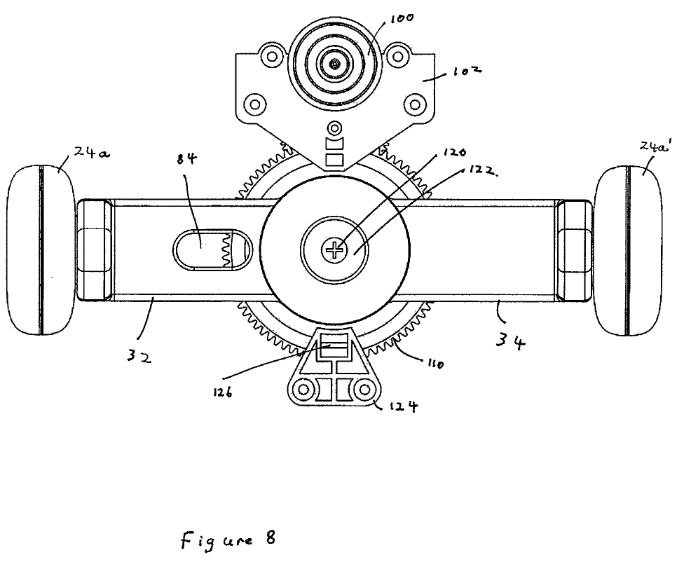

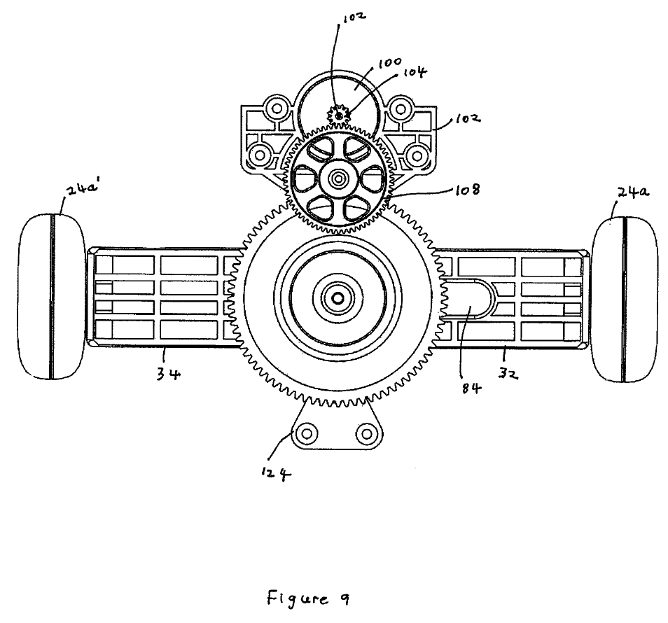

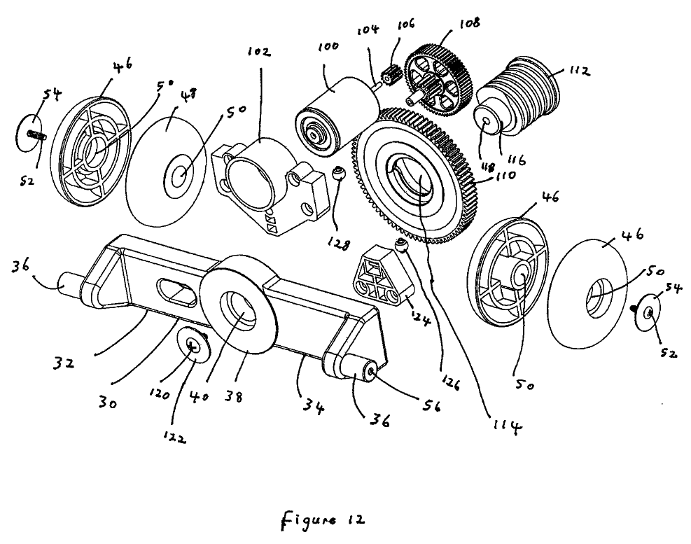

A preferred mechanically linkage which may be utilized to produce such motion is exemplified in FIGS. 4-7. As shown therein, each set of massage heads is provided on an arm 30. Arm 30 has a first end 32 having an axle 36 and a second end 34 having an axle 36. Referring to the exploded view of FIG. 12, arm 30 has a central portion 38 having a pivot opening 40. Pivot opening 40 therefore preferably defines the mid point of arm 32. Pivot opening 40 may be rotatably received on an axle. Alternately, if the position of the massage heads is adjustable relative to the front surface 20, then pivot opening 40 may be rotatably mounted on front end 116 of drive shaft 112 (which therefore defines an axle). Assuming that backrest 12 is generally vertical, then front end 116 defines a generally horizontal axle about which arm 30 pivots.

Referring to FIGS. 5 and 6, in the preferred embodiment, when arms 30 extend generally horizontally as shown in FIGS. 5 and 6, massage heads 24 are in the mid point of the arc or path through which they pass.

Referring to FIG. 12, each massage head 24 may be molded as two separate halves 46, 48, which are secured together by any means known in the art, such as by an adhesive or welding. Massage head 24 may be rotatably or non-rotatably mounted to axle 36 and, preferably, is rotatably mounted thereto. Accordingly, massage heads 24 may have an opening 50 that is sized so as to be slid onto axle 36. Massage heads 24 may be secured to axle 36 by any means known in the art. For example, screw 52 may be passed through washer 54 and into threaded opening 56 of axle 36. Any other means known in the art may be utilized.

In a preferred embodiment of the instant invention, a single motor 58 is utilized to drive each arm 30. Accordingly, referring to FIGS. 4-6, motor 58 is mounted in a motor housing defined by rear motor housing 60 and front motor housing 62. Preferably, front motor housing 62 is removably secured to rear motor housing 60, such as by a plurality of screws. Motor 58 has an output shaft 64 having drive gear 66 mounted thereon. Drive gear 66 is drivingly connected to gear 68, which has a wheel 70 with a drive pin 72 non-rotatably mounted to gear 68. Two generally L shaped drive rods 74, 76 are provided. Drive rod 74 has two drive pins 78, 80 and drive rod 76 has one drive pin 82. Drive pin 78 is received in opening 84 of upper arm 30. Drive pin 80 is received an opening 86 of bottom arm 32 and drive pin 82 is received in an opening 88 of middle arm 30. Accordingly, drive rod 74 is drivingly connected to upper and lower arms 30 and drive rod 76 is drivingly connected to middle arm 30. Each drive rod 74, 76 has a drive opening 90. Each drive opening 90 receives a drive pin 72. As shown in FIG. 5, drive pin 72 is off set from axle 92 about which wheel 90 and gear 68 rotate. Accordingly, as motor 58 turns, it causes drive gear 66 to turn, which drives gears 68 to turn wheels 70 and accordingly drive pins 72, which rotate with gear 68. Each gear 68 will rotate in a different direction. Accordingly, as drive pins 72 rotate, drive rod 74 will be driven upwardly while drive rod 76 will be driven downwardly. Conversely, as gear 68 continues to turn, drive rod 74 will subsequently be driven downwardly while drive rod 76 will be driven upwardly. Accordingly, top and bottom arms 30 will be driven upwardly while middle arm will be driven downwardly. Conversely, middle arm 30 will be driven upwardly when top and bottom arms 30 are driven downwardly. In this way, massage heads 24b, 24b′ will alternately define cooperating pairs with massage heads 24a, 24a′ and subsequently with massage heads 26c, 24c′.

In order to secure drive rods 74 in position, a plurality of cover members 94 may extend over and be secured to cover member mounts 96 on rear surface 44. In addition, glide wheels 98 may be provided to assist in maintaining drive rods 74, 76 in position.

It will be appreciated the various set of constructions may be utilized to drivingly connect motor 58 to arms 30 and to secure drive rods 74, 76 in position.

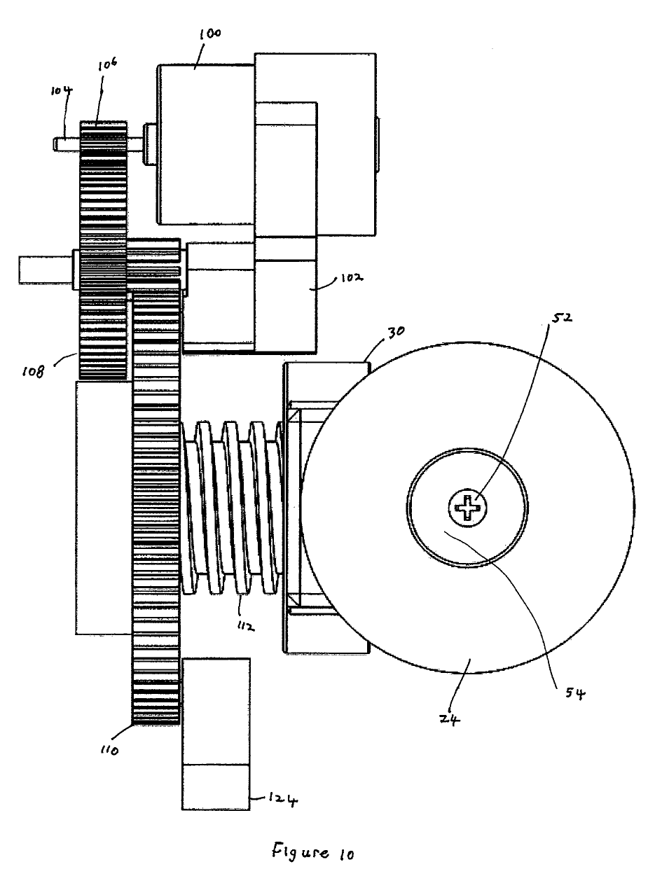

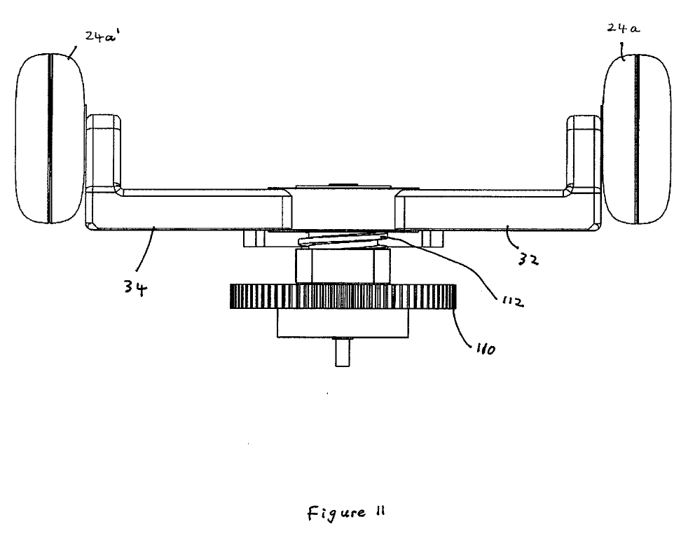

Alternately, or in addition, a massage unit is provided in which the extent to which massage heads 24 extend through openings 22 may be adjustable. Accordingly, massage heads 24 may be movably mounted in a direction generally perpendicular to a plane parallel to the back of the user (e.g. the plain defined by front surface 20). More preferably, each set of massage heads 24 (e.g. each arm 30) is independently movable in the generally perpendicular direction. Referring to FIGS. 8-12, in accordance with this aspect, a depth adjustment motor 100 may be provided in a motor mount 102. Depth adjustment motor 100 may be drivingly connected to massage heads 24 by any means known in the art. For example, depth adjustment motor 100 may be drivingly connected to a driveshaft 112, which is rotatably mounted to the massage unit and moveable in a direction generally perpendicular to the front surface 20. Arm 30 may be pivotally mounted about an axis defined by driveshaft 112. Rotation of the driveshaft in one direction may move arm 30, and massage head(s) 24 outwardly with respect to front surface 20 and openings 22. In the preferred embodiment, each arm 30 has a midpoint, and is rotatably mounted on the driveshaft 112 at the midpoint.

A preferred mechanism is exemplified in FIGS. 8-12. As shown therein depth adjustment motor 100 may be provided with an output shaft 104 having a drive gear 106 non-rotatably mounted thereto. Drive gear 106 may be drivingly connected to speed adjustment gears 108, 110. Drive shaft 112 is received in opening 114 of speed adjustment gear 110 and non-rotatably mounted to drive shaft mount 42 (which is preferably molded as part of back member 44). Drive shaft has a front end 116 having a threaded opening 118. Opening 40 is received on front end 116 and is secured thereto by means of screw 120 and washer 122.

In order to assist in securing speed reduction gear 110 in position, a gear mount stabilizer 124 may be provided. Gear mount stabilizer 124 may be secured to back member 44, such as by screws. A bearing 126 may be provided so as to reduce the friction as speed reduction gear 110 passes by gear mount stabilizer 124. Motor mount 102 may be secured at a fixed location to the massage unit, for example to back member 44, such as by screws and may also assist in retaining speed adjustment gear 110 in place. Accordingly, a bearing 128 may be provided with motor mount 102 so as to reduce the friction as speed adjustment gear 110 passes by motor mount 102.

When depth adjustment motor 100 is operated in a first direction, drive gear 106 will rotate causing speed reduction gear 108 to rotate which causes speed reduction gear 110 to rotate. As drive shaft 112 is non-rotatably mounted to drive shaft mount 42, then the rotation of speed reduction gear 110 will cause speed reduction gear, and the entire depth adjustment mechanism, to move outwardly, with respect to back member 44, thereby driving arm 30, and massage heads 24, outwardly. When depth adjustment motor 100 is operated in the reverse direction, speed reduction gear 110 will be caused to travel rearwardly thereby drawing arm 30, and massage heads 24 mounted thereto, rearwardly, thereby reducing the extent to which massage heads 24 extend outwardly through openings 22.

In the preferred embodiment, this aspect is combined with aspects described hereinabove. That is, each arm 30 is pivotal in an arc in a plane generally parallel to front surface 20, and is moveable in a direction generally perpendicular to front surface 20.

It would be appreciated by those skilled in the art that various additions and modifications may be made to the massage unit of the instant invention and each of those modifications is within the scope of the following claims.

1. A massage unit comprising a first plurality of massage heads positioned to be on one side of a spine of a user when the massage unit is in use, at least one of the massage heads is moveable in alternating directions and sequentially cooperates with other massage heads to define alternating cooperating pairs of massage heads.

2. The massage unit of claim 1 wherein the first plurality of massage heads comprises at least first, second and third massage heads, and the second massage head is positioned between the first and third massage heads and is moveable in alternating directions between a first position proximate the first massage head and a second position proximate the third massage head.

3. The massage unit of claim 2 wherein, in use, the first, second and third massage heads are vertically spaced apart.

4. The massage unit of claim 2 wherein the first and third massage heads are moveably mounted and the first, second and third massage heads move between a first configuration wherein the first and third massage heads are distal to one another and the first and second massage heads are proximate to each other and a second configuration wherein the second massage head is further from the first massage head and closer to the third massage head.

5. The massage unit of claim 4 wherein the first, second and third massage heads oscillate.

6. The massage unit of claim 2 wherein the first and third massage heads are moveably mounted and the second massage heads travels in an alternate direction to the first and third massage heads.

7. The massage unit of claim 2 wherein the first and third massage heads are moveably mounted and the first, second and third massage heads travel in a plane substantially parallel to the back of a user.

8. The massage unit of claim 7 wherein at least one of the first, second and third massage heads is moveably mounted in a direction generally perpendicular to the plane.

9. The massage unit of claim 7 wherein at least two of the massage heads are independently moveably mounted in a direction generally perpendicular to the plane.

10. The massage unit of claim 1 wherein the massage heads travel in an arcuate path.

11. The massage unit of claim 1 wherein the massage unit is built into a chair back of a chair.

12. The massage unit of claim 1 wherein the massage unit is portable and is adapted to be mounted on a chair back of a chair.

13. A massage unit comprising:
a) a first plurality of massage heads positioned to be, when used, on one side of a spine of a user and spaced apart by a first distance;
b) a second plurality of massage heads positioned to be, when used, on another side of a spine of the user and spaced apart by a second distance; and,
c) a massage unit of the first plurality is linked to a massage unit of the other plurality and moves in an opposite direction to the massage unit of the other plurality
wherein, in use, as the first distance increases, the second distance decreases and as the first distance decreases, the second distance increases.

14. The massage unit of claim 13 wherein, in use, at least two of the massage heads of the first plurality move alternately towards each other and away from each other and at least two of the massage heads of the second plurality move alternately towards each other and away from each other.

15. The massage unit of claim 13 wherein each of the first and second plurality of massage heads comprises at least first, second and third massage heads, each second massage head being positioned between a first massage head and a third massage heads and, in use, as the first and second massage heads of the first plurality move towards each other, the third massage head moves away from the second massage head of the first plurality.

16. The massage unit of claim 13 comprising a plurality of sets of massage heads, each set of massage heads comprising at least two massage heads positioned on an arm that, in use, is pivotally mounted about a generally horizontal axis and the arm extends across a spine of a user such that at least one head of each set contacts the user on a different side of the user's spine.

17. The massage unit of claim 16 wherein the arm has a midpoint and the arm is rotatably mounted at the mid point.

18. The massage unit of claim 16 wherein the massage unit includes three arms that are spaced vertically apart.

19. The massage unit of claim 13 wherein the massage heads travel in an arcuate path.

20. The massage unit of claim 17 wherein the massage heads travel in an arcuate path, the arcuate path has a centre and the arm is generally horizontal when the massage heads are at the centre of the arcuate path.

21. The massage unit of claim 13 wherein the massage unit is built into a chair back of a chair.

22. The massage unit of claim 13 wherein the massage unit is portable and is adapted to be mounted on a chair back of a chair.

23. A massage unit for a back of a user comprising:
a) a plurality of sets of massage heads, each set comprising at least first and second massage heads positioned on opposite sides of a spine of the user; and,
b) at least one of the sets of massage heads is moveably mounted and the massage heads of that set are connected together such that the massage heads on one side of the spine of the user move in the opposite direction to the massage heads on the other side of the spine of the user.

24. The massage unit of claim 23 wherein the first massage head sequentially moves in alternate directions.

25. The massage unit of claim 24 wherein the at least first and second massage heads of a set are positioned on an arm that, in use, is pivotally mounted about a generally horizontal axis and the arm extends across the spine of the user.

26. The massage unit of claim 25 wherein the arm has a midpoint and the arm is rotatably mounted at the mid point.

27. The massage unit of claim 23 wherein the massage unit comprises an upper set, a middle set and a lower set, each of which is moveably mounted and the middle set moves in a direction counter to a direction of movement of the upper and lower sets.

28. The massage unit of claim 23 wherein the massage heads travel in an arcuate path.

29. The massage unit of claim 28 wherein the arcuate path has a centre and the arm is generally horizontal when the massage heads are at the centre of the arcuate path.

30. The massage unit of claim 23 wherein the massage unit is built into a chair back of a chair.

31. The massage unit of claim 23 wherein the massage unit is portable and is adapted to be mounted on a chair back of a chair.

32. A massage unit for a back of a user comprising a plurality of sets of massage heads, each set is moveably mounted and comprises at least first and second massage heads positioned on opposite sides of a spine of the user, and at least one set is driven to move in a direction counter to an adjacent set.

33. The massage unit of claim 32 wherein the at least one set sequentially moves in alternate directions.

34. The massage unit of claim 33 wherein each set comprises an arm that, in use, is pivotally mounted about a generally horizontal axis and the arm extends across the spine of the user.

35. The massage unit of claim 33 wherein the massage unit comprises an upper set, a middle set and a lower set, each of which is moveably mounted and the middle set moves in a direction counter to a direction of movement of the upper and lower sets.

36. The massage unit of claim 32 wherein the massage heads travel in an arcuate path.

37. The massage unit of claim 36 wherein the arcuate path has a centre and the arm is generally horizontal when the massage heads are at the centre of the arcuate path.

38. The massage unit of claim 32 wherein the massage unit is built into a chair back of a chair.

39. The massage unit of claim 32 wherein the massage unit is portable and is adapted to be mounted on a chair back of a chair.
